(19) United States
(12) Patent Application Publication
(10) Pub. No.: US 2022/0341587 A1
(43) Pub. Date: Oct. 27, 2022

(54) SOLAR LANTERN SPEAKER

(71) Applicant: Alpine Corporation, City of Industry, CA (US)

(72) Inventor: Zhonghong Chen, Quanzhou City (CN)

(21) Appl. No.: 17/494,653

(22) Filed: Oct. 5, 2021

Related U.S. Application Data
(60) Provisional application No. 63/180,546, filed on Apr. 27, 2021.

(51) Int. Cl. F21V 33/00; H04R 1/02

(52) U.S. Cl. CPC F21V 33/0056; H04R 1/028

(57) ABSTRACT

Provided is a lantern comprising: a) a body; b) a speaker attached to the body; c) a light source attached to the body; d) a rechargeable battery to power one or more of the light source or the speaker; and e) a solar panel attached to the body in a configuration that allows light, from outside the body to contact the solar panel to generate electricity to charge the rechargeable battery; wherein the speaker plays sound and the light source provides illumination.

### CROSS-REFERENCE

The present application claims the benefit of U.S. Appl. No. 63/180,546, filed on Apr. 27, 2021, which is incorporated herein by reference in its entirety.

### BACKGROUND

People use lanterns as a source of illumination. Lanterns, however, have limited functionality. There is a need in the art for lanterns that are suitable as a source of illumination, are easy to use, and provide; additional functionality.

### SUMMARY SECTION OF THE INVENTION

Provided is a portable lantern with a speaker, a source of light, a rechargeable battery, and a solar panel to charge the battery. The lantern having a body, a solar panel placed on top of the body and a light source placed below the solar panel, and a speaker placed below the light source. Any of the above lanterns can have a cuboid body. Any of the above lanterns can be portable and configured to rest on a bottom of a cuboid body. Any of the above lanterns can have two portions that are connected to each other with connectors, which can be in the form of bars (such as flat bars). Any of the above lanterns can have a port to plug in an outside source of power and/or outside source of sound recording. Any of the above lanterns can have a light source that can be a tubular hanging light source that can attached to the body.

Provided is a portable lantern comprising: a. a body; b. a speaker attached to the body; c. a light source attached to the body; d. a rechargeable batten to power one or more of the light source or the speaker; and e.

a solar panel attached to the body in a configuration that allows light from outside the body to contact the solar panel to generate electricity to charge the rechargeable battery; wherein the speaker plays sound and the light source provides illumination. The body can be cuboid. The body can have an upper and a lower portion connected together with connectors. The top of the upper portion can have a solar panel attached to a top and the bottom of upper portion can have a source of light extending downward. The connectors can be bars. The bars can be flat. The solar panel can be placed on the upper portion of the body. The lantern can be a cavity between the upper and lower portions. The light source can be placed inside the cavity of the body. the light source is cylindrical. The speaker can be placed in the body below the light source. The lantern can further have a switch and a port accessible from outside of the body. The light source can illuminate in 360 degrees in a horizontal plane. The lantern can further include of a wireless processor for receiving audio content. The light source can be synchronized with the sound played on the speaker. The lantern can have an additional speaker.

Provided is a lantern comprising: a. a body having an upper and a lower portion, the upper and lower forming a cavity; b. a speaker attached to the body; c. a light source attached to the body; d. a solar panel attached to the body in a configuration that allows light from outside the body to contact the solar panel to generate electricity to charge the rechargeable battery; e. a rechargeable battery to power one or more of the light source or the speaker; f. a wireless processor configured to communicate in a wireless fashion to obtain audio content; and g. an upper and lower portion connected together with connectors; wherein the top of the upper portion has a solar panel attached to a top and the bottom of upper portion has a source of light extending downward. The light source can be cylindrical. The connectors can be bars. The bars can be flat.

### BRIEF DESCRIPTION OF THE INVENTION

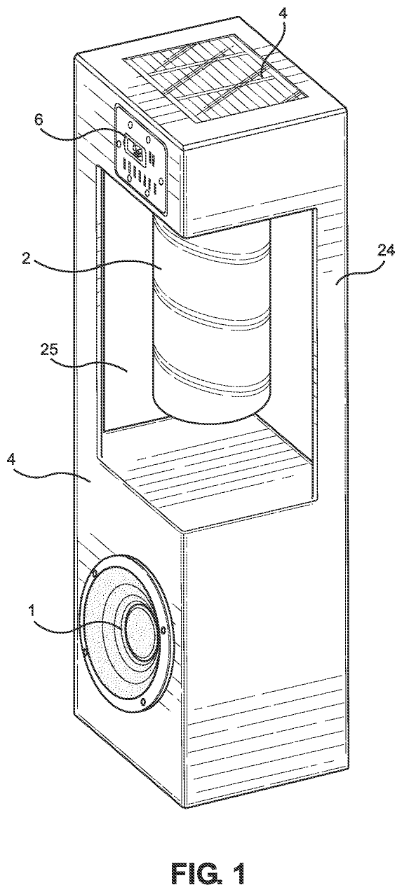

FIG. 1 illustrates a lantern with a speaker, a source of light, a rechargeable battery, and a solar panel.

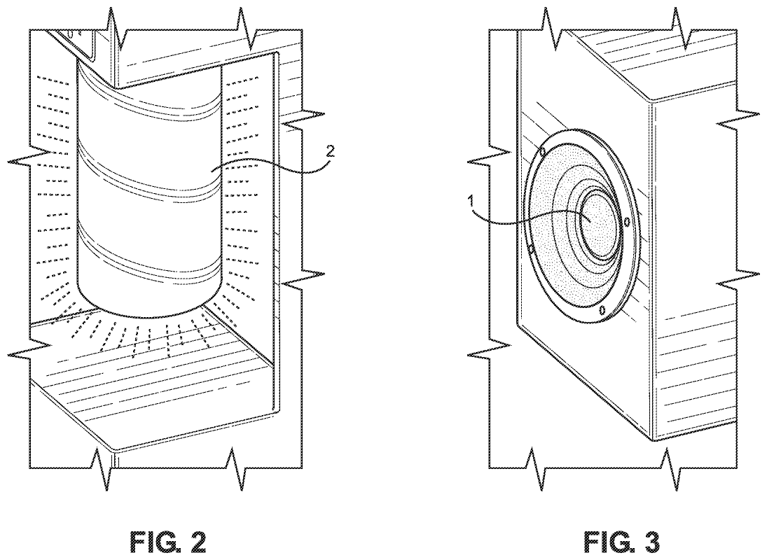

FIG. 2 illustrates the light source of the lantern.

FIG. 3 illustrates the speaker of the lantern.

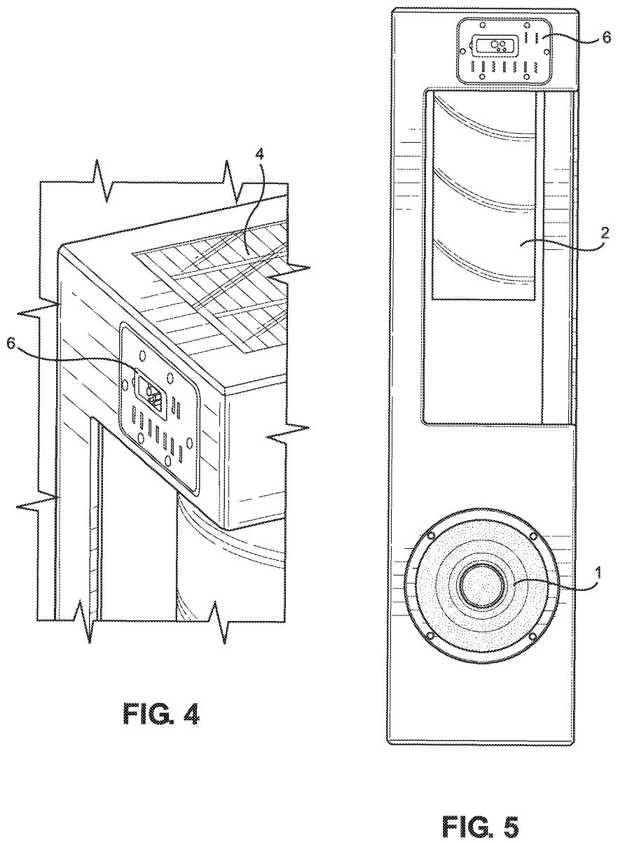

FIG. 4 illustrates a port of the lantern.

FIG. 5 illustrates a side view of the lights source of the lantern.

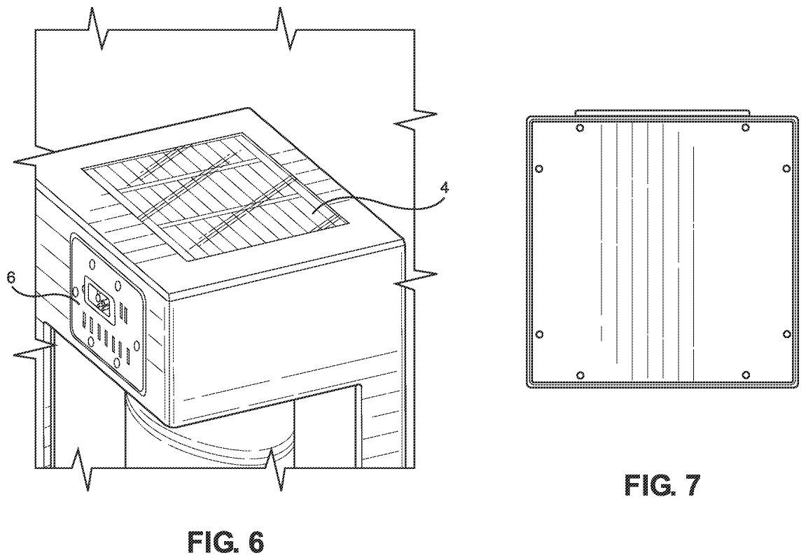

FIG. 6 illustrates a solar panel of the lantern.

FIG. 7 illustrates a bottom view of the lantern of FIG. 1.

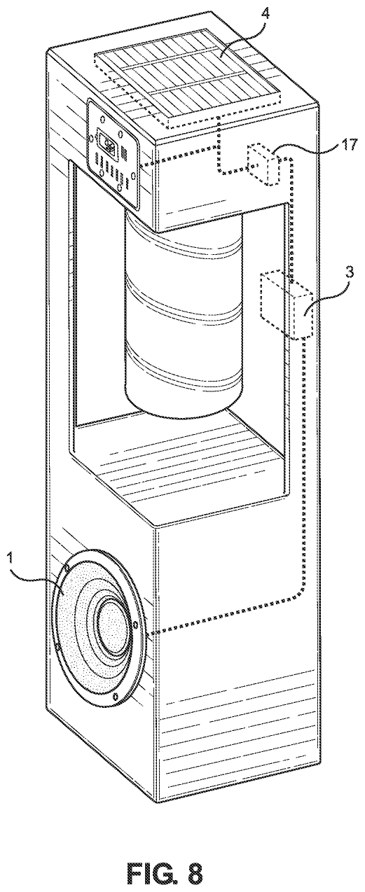

FIG. 8 illustrates electronic communication between the solar panel, rechargeable battery, and the speaker.

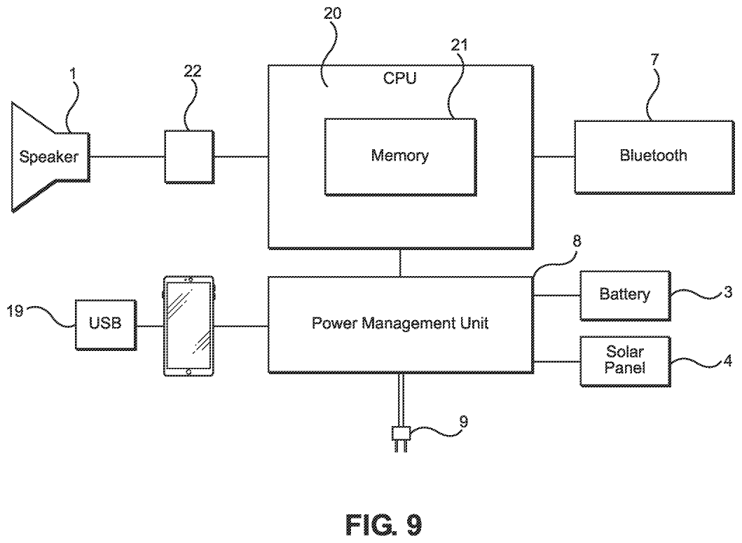

FIG. 9 illustrates the electronic components of the speaker.

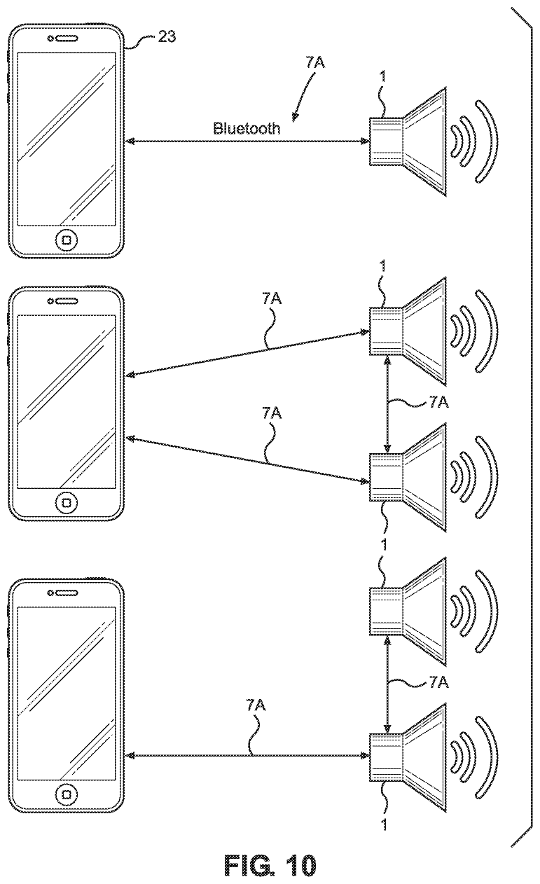

FIG. 10 illustrates alternative networking arrangements.

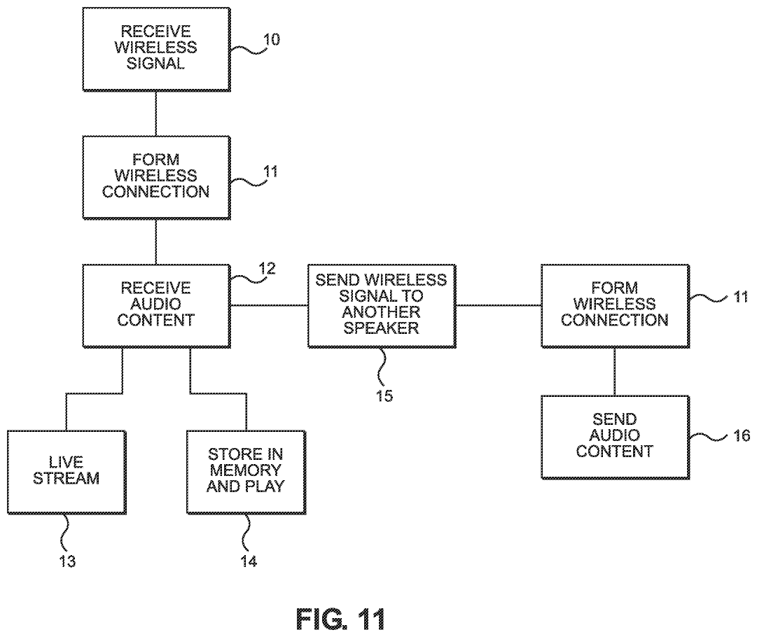

FIG. 11 illustrates a flow chart with steps for establishing wireless communication.

### DETAILED DESCRIPTION OF THE INVENTION

Provided is a portable lantern primarily for outdoor use, such as for placement in a garden, with a speaker 1, a source of light 2, a rechargeable battery 3, and a solar panel 4 to charge the battery 3. The speaker 1 can be configured to communicate with wireless protocol. A user can connect to the speaker 1 in a wireless fashion and play audio over the speaker 1.

The lantern can have a body 5 where a rectangular (including a square) solar panel 4 can be placed on the top of the body. The solar panel 4 can charge the battery 3 that powers the speaker 1 and/or the source of light 2. Alternatively, a port, 6 such as a USB 19 can be used to charge and/or power the source of light 2 and the speaker 1 from an external source of electricity. The port 6 can also be used to charge the battery. The source of light 2 can be one or more LED light sources placed inside of a transparent casing.

In one embodiment, the solar panel 4 can be placed on top, and a light 2 can be placed below the solar panel. The light 2 can extend down from the top portion of housing 5 to the bottom. The light 2 can be a hanging light, and/or have a tubular structure, and/or be attached at the top portion of the body 5 of the lantern. The lantern body 5 can have a cavity 25 inside where the light 2 illuminates in 360 degrees with minimal obstruction. In one embodiment, the lantern lacks a glass, plastic, or other transparent material used as a window to cover the cavity 25. In another embodiment, the lantern has such transparent material to cover cavity 25.

In one embodiment, the lantern body 5 can be cuboid, with the ends of the cuboid configured to be top and bottom of the cuboid. The middle portion of the cuboid can have a cavity 25 for placement of a light source 2, such as a hanging light source.

In one embodiment, the lantern body 5 has an upper portion and a lower portion that are connected together with one or more connectors 24, which can be two thin flat bars. The upper and lower portion can have a height of about one inch to 12 inches each, such as 2 inches to 10 inches. The upper and the lower portion can house electronic components inside of them. A cavity 25 can be formed in between the upper and the lower portions of the body. A solar panel 4 can be placed on the top portion of the body 5, and a light source 2 hangs down from the top portion of the body, on opposite side of the solar panel. A speaker 1 can be placed inside of the lower portion of the body 5. The light source 2 can be then situated in a cavity 25 that is formed by the upper and the lower portions of the body 5. A port 6 for receiving electronic communication and/or power can also be placed on top portion of the lantern.

In one embodiment, a speaker 1 can be placed below the light 2. The body 5 can have a space on the bottom for placement of the speaker 1. The speaker 1 can have a net that is placed on an opening of the body 5. Instead of a net and/or in addition, the body 5 can be configured to have a plurality of openings for passage of sound. A user can connect to the speaker 1 and light source 2 with Bluetooth 7 (signal 7A) configured for wireless communication.

The light source 2 placed inside of the body 5 can be LED (light emitting diodes) and can provide white and/or color changing and/or strobing light. The strobing light and/or colors can be synchronized with the sound played on the speaker 1.

A solar panel 4 can be placed on the body in a configuration that allows ambient, light to contact the solar panel. Typically, the lantern has an opening on top, and the solar panel can be placed on the opening and seals the opening on top. The solar panel 4 charges the rechargeable battery 3. The solar panel 4 can be placed at an angle or in a horizontal plane. The solar panel 4 can be rectangular (including square) in shape.

The figures illustrate an embodiment of the lantern. As illustrated in FIGS. 1-8, the body 5 of the lantern has two portions, with the upper and the lower portions connected by two connectors 24 attached to the opposite dies of the body 5. The connectors 24 are flat piece of bars that minimize blockage of light. The body 5 has a rectangular/square shape. A cavity 25 forms in between the upper and the lower body 5. A light source 2 is attached to the lower portion of the upper part of the body 5 and extends inside of the cavity 25. The light source 2 can be cylindrical, and provide 360 degrees of illumination. A speaker 1 is placed on the bottom part of the body 5. A port 6 and/or switches are placed on side of the upper part of the body 5. A solar panel 4 is placed on the top of the body.

FIG. 7 illustrates the bottom of the bottom of the lantern.

An internal switch can be present in between the solar panel 4 and the battery 3. The electronics can further include a light sensor, which can switch on or off the charging of the rechargeable battery 3 when the ambient light level is below a certain threshold. When light falls below a predetermined level, the internal switch may cut power from the solar panel to the battery. In another embodiment, the internal switch does not exist. An external switch (placed next to port 6) can be used to cut power from the battery to the speaker, and/or entirely shut does the speaker system other than for allowing the battery to be charged by the solar panel 4. Port 6 can also be used to attach an external source of electricity to charge battery 3 or alternatively, to charge a smart phone 23 or other electronic device with battery 3.

FIG. 9 illustrates exemplary communication between the different electronic components. CPU (Central processor unit) 20 can be a microcontroller with internal memory 21 CPU (Central processor unit) 20 can be in communication with speaker 1 through driver 22. CPU 20 can also be in communication with a Power Management Unit 8 can control and monitor the electrical current and voltage of the speaker system, including battery 3, solar panel 4, and external source of electricity or smart phone attached to port 6. The Power Management Unit 8 can have a light sensor. CPU 20 can also be in communication with Bluetooth chip 7 configured for wireless communication. There can also be a wire/plug 9 for plugging the lantern into an outside source of electricity.

FIG. 10 illustrates possible networking arrangements. The top arrangement illustrates a simple network with electronic device of a user (smart phone 23) and one speaker. The middle illustration shows a mesh network where each speaker can be configured to communicate with the smart phone 23 and every other speaker. The user's phone is also configured to communicate with each speaker. The bottom illustration shows one speaker acting as a master, and then communicating with all the other speakers, in this body sending audio content to the other speakers.

FIG. 11 illustrates wireless electronic communication between the user's device and the speaker. The user would make a wireless connection, such as by Bluetooth, to pair the speaker with a user's electronic device, such as a cellular phone, a tablet computer, or a dedicated music player. The user can then play the contents (such as songs) over the speaker. After receiving a wireless signal 10, the speaker system forms connection (pairs) 11 with the user's device. The speaker then receives audio content 12 from the user's device. The audio content can be played as a live stream 13 (with a minimal buffer as needed) or stored in memory and played 14. If the speaker can be configured to network with other speaker, the speaker can then send a wireless signal to another speaker 15 and form a wireless connection (pair) with another speaker and send the audio content 16 to the other speaker to be played in a synchronous fashion.

Alternatively, a wired connection can be made with the port 6 (such as the USB 19) to play the audio content (songs) and/or to charge the user's electronic device. The audio content can be uploaded from a storage device like a flash drive into the speaker's memory and played over the speaker overtime.

### REFERENCES

1. Speaker
2. Light Source
3. Rechargeable Battery
4. Solar Panel
5. Body
6. Port
7. Bluetooth
7A. Bluetooth Communication
8. Power Management Unit
9. Wire/plug
10. Receive Wireless Signal
11. Form Wireless Connection
12. Receive Audio Content
13. Live Stream
14. Store in Memory and Play
15. Send Wireless Signal to Another Speaker
16. Send Audio Content
17. Internal Switch
18. External Switch
19. USB
20. CPU
21. Memory
22. Speaker Driver
23. Smart Phone
24. Connectors
25. Cavity

What is claimed is:

1. A portable lantern comprising
a. a body;
b. a speaker attached to the body;
c. a light source attached to the body;
d. a rechargeable battery to power one or more of the light source or the speaker; and
e. a solar panel attached to the body in a configuration that allows light, from outside the body to contact the solar panel to generate electricity to charge the rechargeable battery;
wherein the speaker plays sound and the light source provides illumination.

2. The lantern of claim 1, wherein the body is cuboid.

3. The lantern of claim 1, wherein the body has an upper and a lower portion connected together with connectors.

4. The upper portion of claim 3, wherein the top of the upper portion has a solar panel attached to a top and the bottom of upper portion has a source of light extending downward.

5. The lantern of claim 3, wherein the connectors are bars.

6. The lantern of claim 4, wherein the bars are flat.

7. The lantern of claim 3, wherein the solar panel is placed on the upper portion of the body.

8. The lantern of claim 3, wherein the lantern has a cavity between the upper and lower portions.

9. The lantern of claim 8, wherein the light source is placed inside the cavity of the body.

10. The lantern of claim 9, wherein the light source is attached to the upper portion of the body and does not touch the lower portion of the body.

11. The lantern of claim 1, wherein the light source is cylindrical.

12. The lantern of claim 1, wherein the speaker is placed in the body below the light source.

13. The lantern of claim 1, further comprising a switch and a port accessible from outside of the body.

14. The lantern of claim 1, wherein the light source illuminates in 360 degrees in a horizontal plane.

15. The lantern of claim 1, further comprising of a wireless processor for receiving audio content.

16. The lantern of claim 1, wherein the light source is synchronized with the sound played on the speaker.

17. A portable lantern comprising:
a. a body having an upper and a lower portion, the upper and lower forming a cavity;
b. a speaker attached to the body;
c. a light source attached to the body;
d. a solar panel attached to the body in a configuration that allows light from outside the body to contact the solar panel to generate electricity to charge the rechargeable battery;
e. a rechargeable battery to power one or more of the light source or the speaker;
f. a wireless processor configured to communicate in a wireless fashion to obtain audio content; and
g. an upper and lower portion connected together with connectors;
wherein the top of the upper portion has a solar panel attached to a top and the bottom of upper portion has a source of light extending downward.

18. The lantern of claim 17, wherein the light source is cylindrical.

19. The lantern of claim 17, wherein the connectors are bars.

20. The lantern of claim 19, wherein the bars are flat.
